(19) United States
(12) Patent Application Publication
(10) Pub. No.: US 2019/0247993 A1
(43) Pub. Date: Aug. 15, 2019

(54) Secondary Handle Attachment

(71) Applicant: Peter John Ziamandanis, Albany, NY (US)

(72) Inventor: Peter John Ziamandanis, Albany, NY (US)

(21) Appl. No.: 16/290,483

(22) Filed: Mar. 1, 2019

Related U.S. Application Data
(63) Continuation-in-part of application No. 16/244,766, filed on Jan. 10, 2019.
Application No. 16/244,766 is a continuation-in-part of application No. 16/188,710, filed on Nov. 13, 2018.
Application No. 16/188,710 is a continuation-in-part of application No. 16/042,291, filed on Jul. 23, 2018.
(60) Provisional application No. 62/630,933, filed on Feb. 15, 2018.

(51) Int. Cl. B25G 3/24

(52) U.S. Cl. CPC B25G 3/24; A01B 1/026

(57) ABSTRACT

A secondary handle attachment includes a handle, an upper elongated bracket, a lower elongated bracket, at least one left fastener, and at least one right fastener. The upper elongated bracket and the lower elongated bracket each comprises an inner surface and an outer surface. The upper elongated bracket and the lower elongated bracket are concentrically positioned with each other and positioned around a primary handle of the tool. The handle is terminally connected to the outer surface of the upper elongated bracket. The at least one left fastener and the at least one right fastener are oppositely positioned of each other about the upper elongated bracket. As a result, the lower elongated bracket is laterally mounted to the upper elongated bracket by the at least one left fastener and the at least one right fastener thus securing the secondary handle attachment to the primary handle of the tool.

The current application is a continuation-in-part (CIP) application of a U.S. non-provisional application Ser. No. 16/244,766 filed on Jan. 10, 2019. The U.S. non-provisional application Ser. No. 16/244,766 claims a priority to U.S. non-provisional application Ser. No. 16/188,710 filed on Nov. 13, 2018. The U.S. non-provisional application Ser. No. 16/188,710 claims a priority to U.S. non-provisional application Ser. No. 16/042,291 filed on Jul. 23, 2018. The U.S. non-provisional application Ser. No. 16/042,291 claims a priority to a U.S. provisional application Ser. No. 62/630,933 filed on Feb. 15, 2018.

### FIELD OF THE INVENTION

The present invention relates generally to a handle attachment for cleaning tools, garden tools, or any household tools are that normally equipped with a primary handle. More specifically, the present invention is a secondary handle attachment that enables a user to efficiently utilize cleaning tools, garden tools, or any other household tools without having to bend over to apply pressure against the ground surface or lift material being picked up by the tool.

### BACKGROUND OF THE INVENTION

A mop, an exemplary cleaning tool, is a mass or bundle of coarse strings or yarn, etc., or a piece of cloth, sponge, or other absorbent material that is attached to a pole or stick. It is used to soak up liquid, for cleaning floors and other surfaces, to mop up dust, or for other cleaning purposes. Even though there have been many different upgrades and changes done to the mop head, the handle has been consistent throughout all of those changes as the handle is shaped into a circular and elongated body. Standard mops can cause injuries due to awkward usage as the standard mops generally just have one handle that is connected to support the mop head. The user is meant to grasp the handle with both hands to properly use the standard mops. This requires the user to bend over, which is not conducive to protecting the user's back. A standard shovel, an exemplary garden tool, is a scoop that is connected to a circular and elongated handle. Standard shovels can cause injuries due to awkward usage. Shovels generally just have one handle and one support shaft connected to the head. The user is meant to grasp the handle with one hand and grasp the support shaft with the other hand. The design of almost all shovels requires the operator to use the shovel while bending over, which is not conducive to protecting the user's back. Resultantly, there is a need for an updated handle that is easy to use and maintain, while simultaneously reducing the need to bend over and the related stress to the user's back. What is further needed is an attachment device that enables the user to apply downward cleaning pressure to the mop with both hands while standing in an upright position.

It is therefore an object of the present invention to provide a secondary handle attachment that provides additional grasping area for existing tools with a primary handle. The primary handle is the existing handles of the cleaning tools, garden tools, or any other household tools. A handle of present invention extends from the primary handle as a pair of brackets of the present invention is mounted around the primary handle. The handle enables the user to grasp the tool from multiple gripping positions with one hand while the other hand is utilized to grasp the primary handle. Resultantly, the user is able to utilize the present invention along with the primary handle to eliminate bending over at the waist or spine during usage of the tool. Such motion prevents the user from worrying about damage to the user's back or body during use, while further allowing optimal leverage to apply pressure to ground surface or lifting material from the ground.

### BRIEF DESCRIPTION OF THE DRAWINGS

FIG. 1 is a top perspective view of the present invention.

FIG. 2 is a top exploded view of the present invention.

FIG. 3 is a side view of the present invention, wherein the dash lines illustrate the first central axis, the second central axis, the supplementary linear pair of angles, the acute angle, and the obtuse angle.

FIG. 4 is a detailed view of the present invention, showing the upper friction enhancing layer and the lower friction enhancing layer.

FIG. 5 is a bottom perspective view of the upper elongated bracket of the present invention.

FIG. 6 is a top perspective view of the lower elongated bracket of the present invention.

FIG. 7 is an illustration of a dust mop, wherein the present invention is attached to the dust mop.

### DETAIL DESCRIPTIONS OF THE INVENTION

All illustrations of the drawings are for the purpose of describing selected versions of the present invention and are not intended to limit the scope of the present invention.

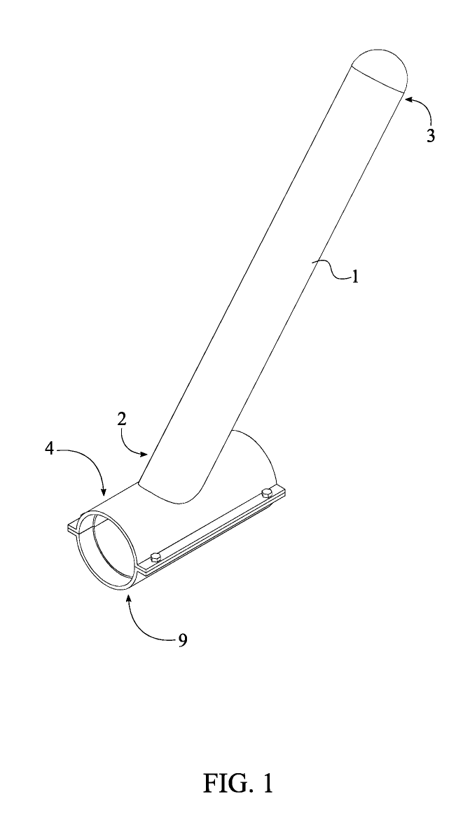

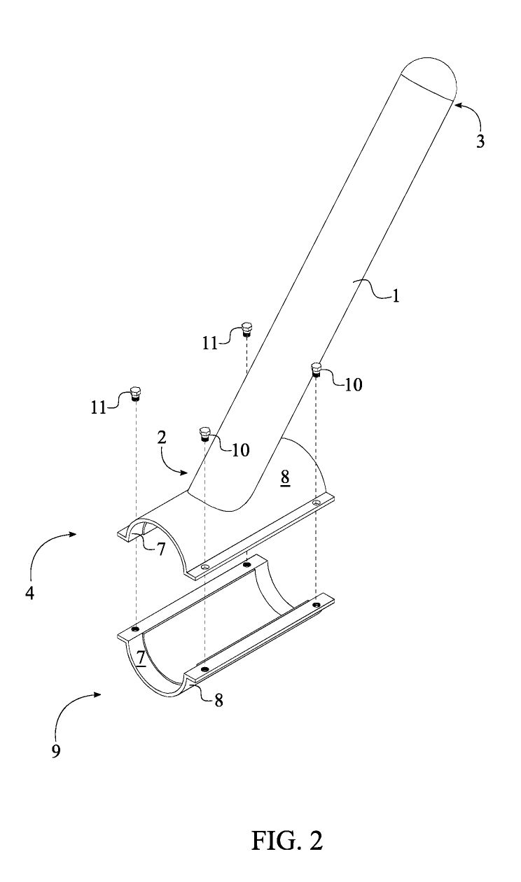

The present invention is a secondary handle attachment that enables the user to safely dry floors, remove contaminated liquid, clean floors, remove dust, and complete yard work without having to bend down at the waist or body during usage. The present invention is designed to work with a primary handle of existing tools such as a sponge mop, dust mop, wet mop, garden shovels, snow shovels, broom, rake, and hoe. The present invention comprises a handle 1, an upper elongated bracket 4, a lower elongated bracket 9, at least one left fastener 10, and at least one right fastener 11 as shown in FIGS. 1-2. More specifically, the present invention enables the user to grasp the tool with multiple gripping positions with one hand while the other hand is utilized to grasp the primary handle thus occupying both hands without having to bend down.

In reference to the general configuration of the present invention, as shown in FIGS. 1-2, the upper elongated bracket 4 and the lower elongated bracket 9 each comprises an inner surface 7 and an outer surface 8. The upper elongated bracket 4 and the lower elongated bracket 9 are concentrically positioned with each other so that the primary handle can be circumferencely secured. The handle 1 that allows the user to grasp the present invention during usage is terminally connected to the outer surface 8 of the upper elongated bracket 4. The at least one left fastener 10 and the at least one right fastener 11 are oppositely positioned of each other about the upper elongated bracket 4 so that the lower elongated bracket 9 and the upper elongated bracket 4 can be laterally mounted to each other by the at least one left fastener 10 and the at least one right fastener 11. The opposite positioning of the at least one left fastener 10 and the at least one right fastener 11 ensure the symmetrical positioning of the present invention with respect to the primary handle.

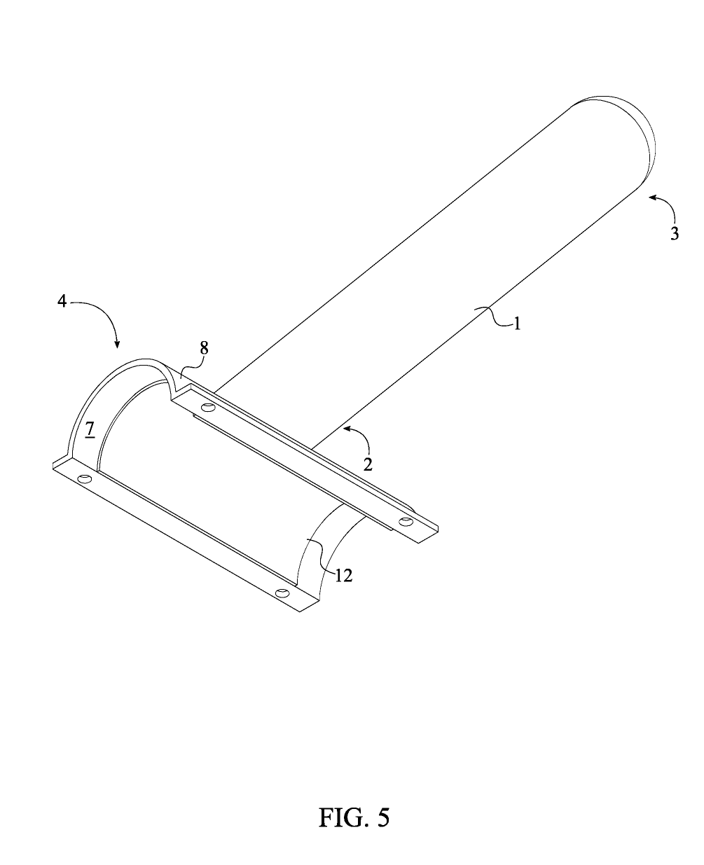

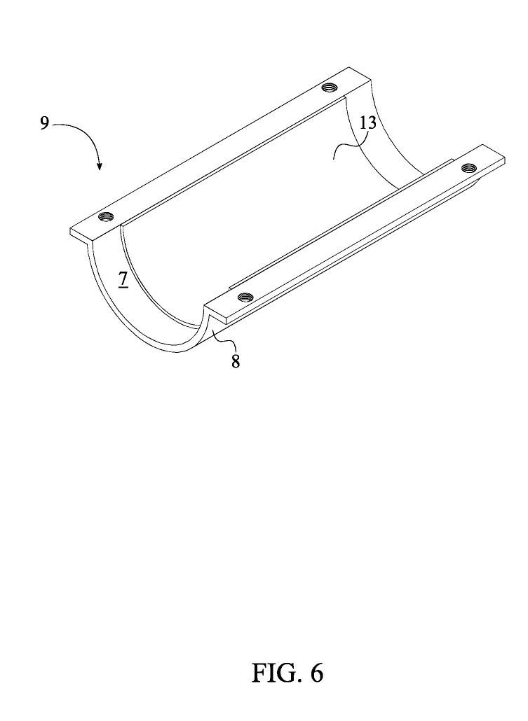

The upper elongated bracket 4 and the lower elongated bracket 9 delineate the same structural form within the present invention. Preferably, the upper elongated bracket 4 and the lower elongated bracket 9 are formed into a C-shaped bodies so that the upper elongated bracket 4 and the lower elongated bracket 9 are able to laterally match the circular shape of the primary handle. In reference to FIG. 2, FIG. 5, and FIG. 6, the inner surface 7 of the upper elongated bracket 4 and the inner surface 7 of the lower elongated bracket 9 are circumferencely positioned with each other. The outer surface 8 of the upper elongated bracket 4 and the outer surface 8 of the lower elongated bracket 9 being circumferencely positioned with each other. Furthermore, the upper elongated bracket 4 and the lower elongated bracket 9 each comprises a first edge 5 and a second edge 6, wherein the inner surface 7 and the outer surface 8 are linearly extended from the first edge 5 to the second edge 6. When the present invention is installed around the primary handle, the inner surface 7 of the upper elongated bracket 4 and the lower elongated bracket 9 position adjacent and against an outer surface of the primary handle. The outer surface 8 of the upper elongated bracket 4 and the lower elongated bracket 9 position offset from the outer surface of the primary handle thus allowing the rest of the components of the present invention to be integrated.

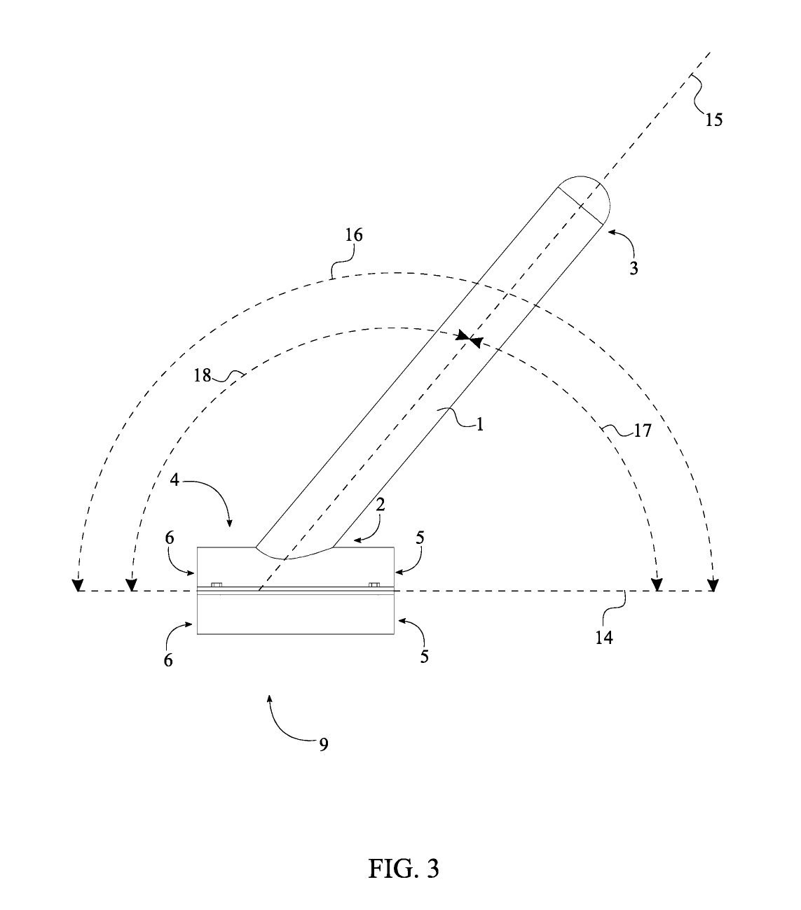

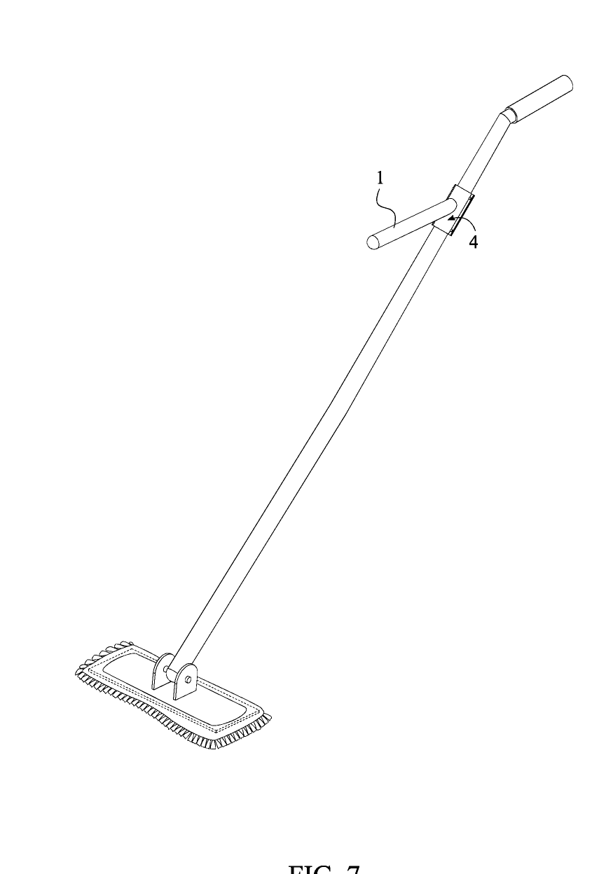

The handle 1 is an elongated and circular body that preferably extends upward from the primary handle. The handle 1 delineates an ergonomic surface area so that the users can comfortably grasp the present invention. In reference to FIGS. 1-2, the handle 1 comprises a fixed end 2 and a free end 3. The fixed end 2 and the free end 3 are positioned opposite of each other about the handle 1 delineates the two ends of the handle 1. The fixed end 2 is terminally connected to the outer surface 8 of the upper elongated bracket 4 thus resulting a stationary position for the handle 1 within the primary handle. The free end 3 is oriented away from the outer surface 8 of the upper elongated bracket 4 so that the handle 1 is able to provide the secondary surface area to grasp the tool. The present invention further comprises a first central axis 14, a second central axis 15, and a supplementary linear pair of angles 16 as shown in FIG. 3. More specifically, the first central axis 14 concentrically traverses through the upper elongated bracket 4 and the lower elongated bracket 9. In other words, the first central axis 14 is concentrically positioned with the primary handle. The second central axis 15 concentrically traverses through the handle 1 as the second central axis 15 angularly positions with the first central axis 14. The supplementary linear pair of angles 16 is delineated by the first central axis 14 and the second central axis 15, wherein the supplementary linear pair of angles 16 comprises an acute angle 17 and an obtuse angle 18. As shown in FIG. 3, the acute angle 17 is positioned adjacent to the first edge 5 and the obtuse angle 18 is positioned adjacent to the second edge 6. Preferably, the first edge 5 is positioned adjacent to a head of the tool and the second edge 6 is positioned adjacent to a handle grip of the tool as shown in FIG. 7. However, the present invention is not limited to aforementioned configurations as the first edge 5 can be positioned adjacent to a handle grip of the tool and the second edge 6 can be positioned adjacent to a head of the tool.

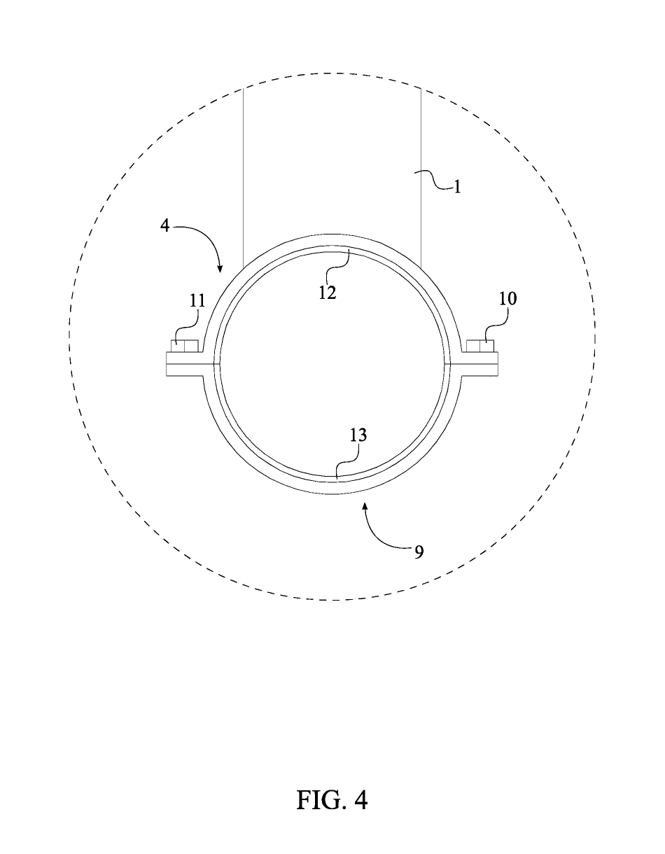

In reference to FIG. 4, the present invention further comprises an upper friction enhancing layer 12 and a lower friction enhancing layer 13 to increase the friction between the present invention and the primary handle. The upper friction enhancing layer 12 and the lower friction enhancing layer 13 are preferably made from flexible rubber or foam to tightly attach the upper elongated bracket 4 and the lower elongated bracket 9 to the primary handle. More specifically, the upper friction enhancing layer 12 is superimposed onto the inner surface 7 of the upper elongated bracket 4. The lower friction enhancing layer 13 is superimposed onto the inner surface 7 of the lower elongated bracket 9. Resultantly, the upper friction enhancing layer 12 and the lower friction enhancing layer 13 are sandwiched in between the outer surface of the primary handle and the inner surface 7 of the upper elongated bracket 4 and the lower elongated bracket 9.

The at least one left fastener 10 and the at least one right fastener 11 each comprises a first interlocking portion and a second interlocking portion. The first interlocking portion and the second interlocking portion are engaged with each other thus delineating the attachment between the lower elongated bracket 9 and the upper elongated bracket 4. Depending upon different types fasteners, the first interlocking portion can be integrated onto the upper elongated bracket 4 or the lower elongated bracket 9 as the second interlocking portion can be integrated onto the corresponding upper elongated bracket 4 or the lower elongated bracket 9.

Depending upon a first configuration, the lower elongated bracket 9 is mounted to the upper elongated bracket 4 by the at least one left fastener 10 and the at least one right fastener 11 that are operatively pre-connected to the upper elongated bracket 4. More specifically, the first interlocking portion is integrated onto the upper elongated bracket 4, and the second interlocking portion is integrated onto the lower elongated bracket 9. Resultantly, the first interlocking portion engages or attaches with the second interlocking portion thus attaching the lower elongated bracket 9 to the upper elongated bracket 4.

Depending upon a second configuration, the upper elongated bracket 4 is mounted to the lower elongated bracket 9 by the at least one left fastener 10 and the at least one right fastener 11 that are operatively pre-connected to the lower elongated bracket 9. More specifically, the first interlocking portion is integrated onto the lower elongated bracket 9, and the second interlocking portion is integrated onto the upper elongated bracket 4. Resultantly, the first interlocking portion engages or attaches with the second interlocking portion thus attaching the upper elongated bracket 4 to the lower elongated bracket 9.

The at least one left fastener 10 and the at least one right fastener 11 of the present invention are preferably a plurality of screw fasteners as shown in FIG. 2. More specifically, each of the plurality of screw fasteners comprises a male fastener, a female fastener, and an opening. The female fastener functions as the second interlocking portion and is integrated into a flat section of the lower elongated bracket 9. The opening traverses through a flat section of the upper elongated bracket 4. Once the lower elongated bracket 9 and the upper elongated bracket 4 are laterally positioned around the primary handle and the opening is concentrically aligned with the female fastener, the male fastener that functions as the first interlocking portion can be inserted through the opening and threadedly engaged with the female fastener. As a result, the male fastener is able to attach to the female fastener thus clamping the lower elongated bracket 9 and the upper elongated bracket 4 against the primary handle. However, the at least one left fastener 10 and the at least one right fastener 11 are not limited to the preferred fastening mechanism and can include a male and female threaded fastener, a clamp fastener, a snap fastener, and a latch fastener.

Although the invention has been explained in relation to its preferred embodiment, it is to be understood that many other possible modifications and variations can be made without departing from the spirit and scope of the invention as hereinafter claimed.

What is claimed is:

1. A secondary handle attachment comprises:
a handle;
an upper elongated bracket;
a lower elongated bracket;
at least one left fastener;
at least one right fastener;
the upper elongated bracket and the lower elongated bracket each comprises an inner surface and an outer surface;
the upper elongated bracket and the lower elongated bracket being concentrically positioned with each other;
the handle being terminally connected to the outer surface of the upper elongated bracket;
the at least one left fastener and the at least one right fastener being oppositely positioned of each other about the upper elongated bracket; and
the lower elongated bracket and the upper elongated bracket being laterally mounted to each other by the at least one left fastener and the at least one right fastener.

2. The secondary handle attachment as claimed in claim 1 comprises:
the inner surface of the upper elongated bracket and the inner surface of the lower elongated bracket being circumferencely positioned with each other; and
the outer surface of the upper elongated bracket and the outer surface of the lower elongated bracket being circumferencely positioned with each other.

3. The secondary handle attachment as claimed in claim 1 comprises:
the handle comprises a fixed end and a free end;
the fixed end being terminally connected to the outer surface of the upper elongated bracket; and
the free end being oriented away from the outer surface of the upper elongated bracket.

4. The secondary handle attachment as claimed in claim 1 comprises:
an upper friction enhancing layer;
a lower friction enhancing layer;
the upper friction enhancing layer being superimposed onto the inner surface of the upper elongated bracket; and
the lower friction enhancing layer being superimposed onto the inner surface of the lower elongated bracket.

5. The secondary handle attachment as claimed in claim 1 comprises:
a first central axis;
a second central axis;
a supplementary linear pair of angles;
the first central axis concentrically traversing through the upper elongated bracket and the lower elongated bracket;
the second central axis concentrically traversing through the handle; and
the supplementary linear pair of angles being delineated by the first central axis and the second central axis.

6. The secondary handle attachment as claimed in claim 5 comprises:
the supplementary linear pair of angles comprises an acute angle and an obtuse angle;
the upper elongated bracket and the lower elongated bracket each comprises a first edge and a second edge;
the inner surface and the outer surface being extended from the first edge to the second edge;
the acute angle being positioned adjacent to the first edge; and
the obtuse angle being positioned adjacent to the second edge.

7. The secondary handle attachment as claimed in claim 1, wherein the lower elongated bracket is mounted to the upper elongated bracket by the at least one left fastener and the at least one right fastener.

8. The secondary handle attachment as claimed in claim 1, wherein the upper elongated bracket is mounted to the lower elongated bracket by the at least one left fastener and the at least one right fastener.

9. A secondary handle attachment comprises:
a handle;
an upper elongated bracket;
a lower elongated bracket;
at least one left fastener;
at least one right fastener;
a first central axis;
a second central axis;
a supplementary linear pair of angles;
the upper elongated bracket and the lower elongated bracket each comprises an inner surface and an outer surface;
the upper elongated bracket and the lower elongated bracket being concentrically positioned with each other;
the handle being terminally connected to the outer surface of the upper elongated bracket;
the first central axis concentrically traversing through the upper elongated bracket and the lower elongated bracket;
the second central axis concentrically traversing through the handle;
the supplementary linear pair of angles being delineated by the first central axis and the second central axis;
the at least one left fastener and the at least one right fastener being oppositely positioned of each other about the upper elongated bracket; and
the lower elongated bracket and the upper elongated bracket being laterally mounted to each other by the at least one left fastener and the at least one right fastener.

10. The secondary handle attachment as claimed in claim 9 comprises:
the inner surface of the upper elongated bracket and the inner surface of the lower elongated bracket being circumferencely positioned with each other; and
the outer surface of the upper elongated bracket and the outer surface of the lower elongated bracket being circumferencely positioned with each other.

11. The secondary handle attachment as claimed in claim 9 comprises:
the handle comprises a fixed end and a free end;
the fixed end being terminally connected to the outer surface of the upper elongated bracket; and
the free end being oriented away from the outer surface of the upper elongated bracket.

12. The secondary handle attachment as claimed in claim 9 comprises:
an upper friction enhancing layer;
a lower friction enhancing layer;
the upper friction enhancing layer being superimposed onto the inner surface of the upper elongated bracket; and
the lower friction enhancing layer being superimposed onto the inner surface of the lower elongated bracket.

13. The secondary handle attachment as claimed in claim 9 comprises:
the supplementary linear pair of angles comprises an acute angle and an obtuse angle;
the upper elongated bracket and the lower elongated bracket each comprises a first edge and a second edge;
the inner surface and the outer surface being extended from the first edge to the second edge;
the acute angle being positioned adjacent to the first edge; and
the obtuse angle being positioned adjacent to the second edge.

14. The secondary handle attachment as claimed in claim 9, wherein the lower elongated bracket is mounted to the upper elongated bracket by the at least one left fastener and the at least one right fastener.

15. The secondary handle attachment as claimed in claim 9, wherein the upper elongated bracket is mounted to the lower elongated bracket by the at least one left fastener and the at least one right fastener.
